(19) United States
(12) Patent Application Publication
(10) Pub. No.: US 2012/0129385 A1
(43) Pub. Date: May 24, 2012

(54) COAXIAL CABLE CONDUCTIVE TAPE WITH A METAL LAYER SURROUNDING A VISUALLY CONTRASTING POLYMER STRENGTH LAYER

(75) Inventor: Alan John Amato, Cheshire, CT (US)

(73) Assignee: JOHN MEZZALINGUA ASSOCIATES, INC., East Syracuse, NY (US)

(21) Appl. No.: 12/951,979

(22) Filed: Nov. 22, 2010

(51) Int. Cl. H01B 9/02; H01R 11/00; H01B 5/00

(52) U.S. Cl. 439/502; 174/133 R; 174/102 R

(57) ABSTRACT

A conductive tape for a coaxial cable with a metal layer surrounding a visually contrasting polymer strength layer. In one example embodiment, a conductive tape for use in a coaxial cable includes an inner metal layer, an outer metal layer, and a polymer strength layer positioned between and adjacent to the inner and outer metal layers. The color or brightness of the polymer strength layer visually contrasts with the outer metal layer.

### BACKGROUND

Typical coaxial cable includes one or more layers of conductive materials for radio frequency (RF) shielding. One common type of shielding is a conductive braid that attenuates interfering electromagnetic fields in the low frequency range. Another common type of shielding is a conductive tape that attenuates interfering electromagnetic fields in the high frequency range.

The conductive tape of a coaxial cable may degrade due to, for example, flexure, unusual stresses, high temperatures, movement by uses, and wind. These stresses on the conductive tape may cause cracks (also known as micro-cracks) in the conductive tape. Cracks in the conductive tape may allow ingress of unwanted RF signals into the coaxial cable or egress of the RF signal transmitted within the coaxial cable. This unwanted ingress and egress of RF signals can cause signal degradation.

The detection of cracks in the conductive tape can be difficult for cable technicians. In particular, the relative narrowness of typical cracks in the conductive tape tends to make the cracks difficult to detect with the naked eye, especially where a cable technician is examining the conductive tape in low-lighting conditions.

### SUMMARY OF SOME EXAMPLE EMBODIMENTS

In general, example embodiments of the present invention relate to a conductive tape for a coaxial cable with a metal layer surrounding a visually contrasting polymer strength layer. The color or brightness of the polymer strength layer visually contrasts with the color or brightness of the metal layer so that any cracks in the metal layer can be visually detected by a cable technician with the naked eye, even in low-lighting conditions. As cracks in the metal layer degrade the shielding effectiveness of the conductive tape, the visual identification of cracks in the metal layer alerts a cable technician to the need to repair or replace the coaxial cable.

In one example embodiment, a conductive tape for use in a coaxial cable includes an inner metal layer, an outer metal layer, and a polymer strength layer positioned between and adjacent to the inner and outer metal layers. The color or brightness of the polymer strength layer visually contrasts with the outer metal layer.

In another example embodiment, a coaxial cable includes a center conductor surrounded by a dielectric, a conductive tape surrounding the dielectric, and a jacket surrounding the conductive tape. The conductive tape includes an inner metal layer surrounding the dielectric, a polymer strength layer surrounding and adjacent to the inner metal layer, and an outer metal layer surrounding and adjacent to the polymer strength layer. The color or brightness of the polymer strength layer visually contrasts with the outer metal layer.

In yet another example embodiment, a coaxial cable having a first coaxial cable connector attached to a first terminal section of the coaxial cable and a second coaxial cable connector attached to a second terminal section of the coaxial cable. The coaxial cable includes a center conductor surrounded by a dielectric, a conductive tape surrounding the dielectric, and a jacket surrounding the conductive tape. The conductive tape includes an inner metal layer surrounding the dielectric, a polymer strength layer surrounding and adjacent to the inner metal layer, and an outer metal layer surrounding and adjacent to the polymer strength layer. The color or brightness of the polymer strength layer visually contrasts with the outer metal layer.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter. Moreover, it is to be understood that both the foregoing general description and the following detailed description of the present invention are exemplary and explanatory and are intended to provide further explanation of the invention as claimed.

### BRIEF DESCRIPTION OF THE DRAWINGS

Aspects of example embodiments of the present invention will become apparent from the following detailed description of example embodiments given in conjunction with the accompanying drawings, in which:

FIG. 1A is a perspective view of an example coaxial cable that terminates on one end with an example connector and that is prepared for termination on the other end with another example connector;

FIG. 1B a is perspective view of a portion of the coaxial cable of FIG. 1A with portions of each layer cut away; and

FIG. 1C is a cross-sectional view of the example coaxial cable of FIG. 1A; and

FIG. 1D is an enlarged view of a portion of the example coaxial cable of FIG. 1A.

### DETAILED DESCRIPTION OF SOME EXAMPLE EMBODIMENTS

Example embodiments of the present invention relate to a conductive tape for a coaxial cable with a metal layer surrounding a visually contrasting polymer strength layer. The color or brightness of the polymer strength layer visually contrasts with the color or brightness of the metal layer so that any cracks in the metal layer can be visually detected by a cable technician with the naked eye, even in low-lighting conditions. As cracks in the metal layer degrade the shielding effectiveness of the conductive tape, the visual identification of cracks in the metal layer alerts a cable technician to the need to repair or replace the coaxial cable.

In the following detailed description of some example embodiments, reference will now be made in detail to specific embodiments of the present invention, examples of which are illustrated in the accompanying drawings. Wherever possible, the same reference numbers will be used throughout the drawings to refer to the same or like parts. These embodiments are described in sufficient detail to enable those skilled in the art to practice the invention. Other embodiments may be utilized and structural, logical and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

### I. Example Coaxial Cable

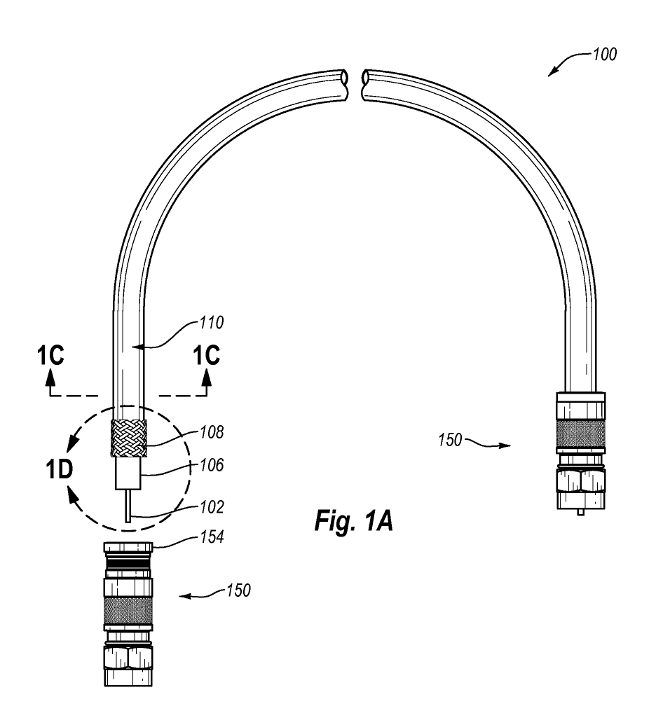

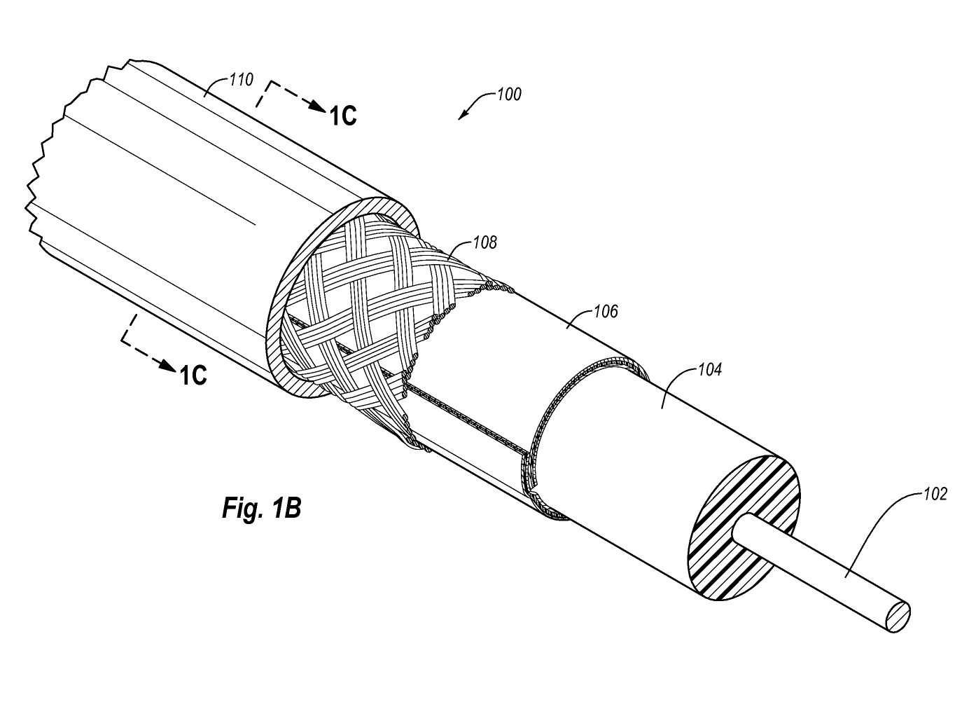

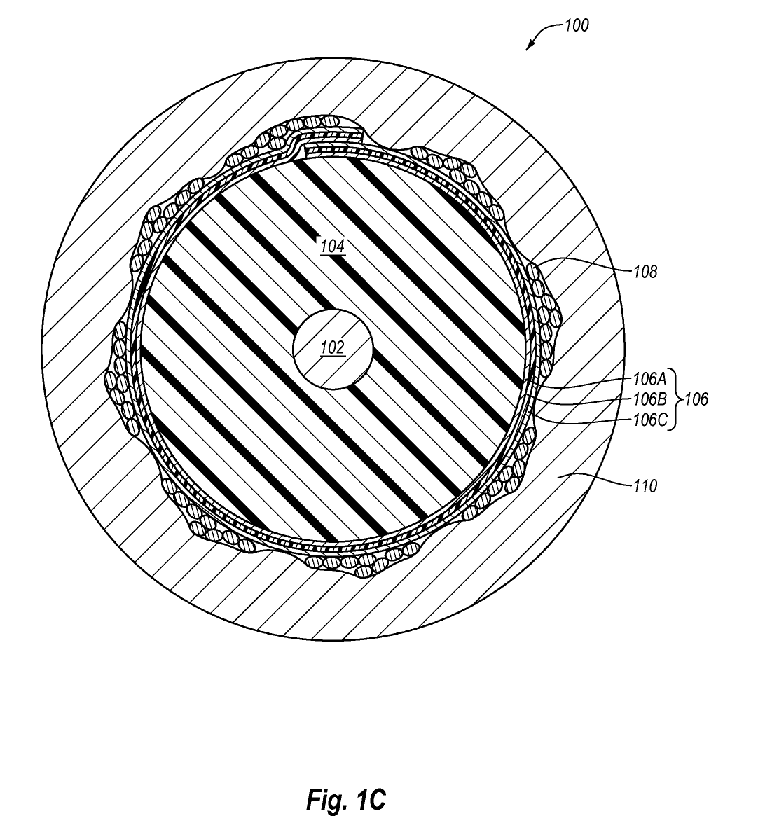

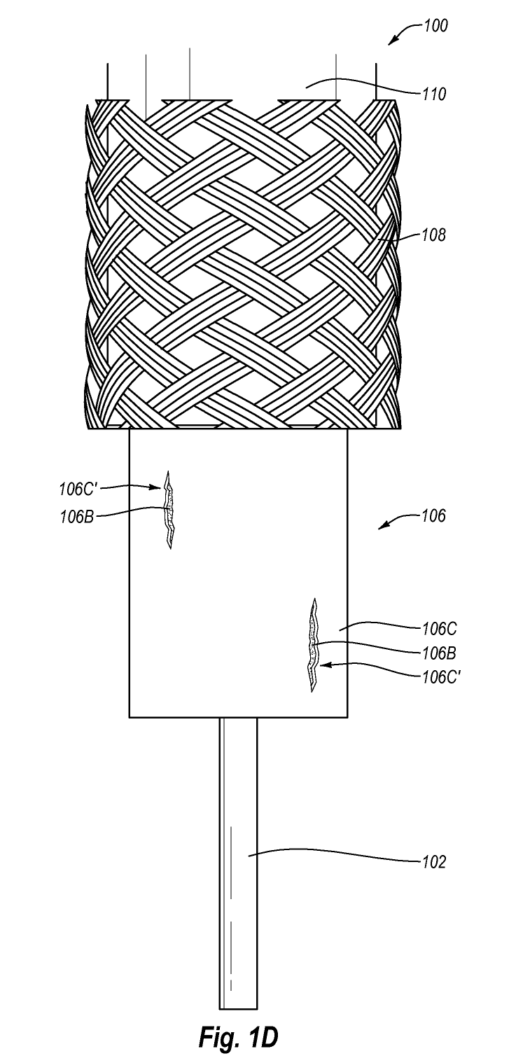

With reference first to FIG. 1A, an example coaxial cable 100 is disclosed. The example coaxial cable 100 can be any type of coaxial cable including, but not limited to, 75 ohm coaxial cable. As disclosed in FIG. 1A, the example coaxial cable 100 is terminated on the right side of FIG. 1A with an example connector 150, and is prepared for termination on the left side of FIG. 1A with a second connector 150. Once the example coaxial cable 100 is terminated on both the right and left sides with the example connectors 150, the example coaxial cable 100 becomes an example coaxial cable jumper. Although the connectors 150 are disclosed in FIG. 1A as F-type male connectors, it is understood that cable 100 can also be terminated with other types of male and/or female connectors (not shown).

With continuing reference to FIG. 1A, and with reference also to FIGS. 1B and 1C, the coaxial cable 100 is a standard-shield coaxial cable that generally includes a center conductor 102 surrounded by a dielectric 104, a conductive tape 106 surrounding the dielectric 104, a braid 108 surrounding the conductive tape 106, and a jacket 110 surrounding the braid 108. As used herein, the phrase “surrounded by” refers to an inner layer generally being encased by an outer layer. However, it is understood that an inner layer may be “surrounded by” an outer layer without the inner layer being adjacent to the outer layer. The term “surrounded by” thus allows for the possibility of intervening layers. Each of these components of the example coaxial cable 100 will now be discussed in turn.

The center conductor 102 is positioned at the core of the example coaxial cable 100. The center conductor 102 may be configured to carry a range of electrical current (amperes) and/or RF/electronic digital signals. In some example embodiments, the center conductor 102 is formed from solid copper, copper-clad aluminum (CCA), copper-clad steel (CCS), or silver-coated copper-clad steel (SCCCS), although other conductive materials are possible. For example, the center conductor 102 can be formed from any type of conductive metal or alloy. In addition, the center conductor 102 can be solid, hollow, stranded, corrugated, plated, or clad, for example.

The dielectric 104 surrounds the center conductor 102, and generally serves to support and insulate the center conductor 102 from the conductive tape 106. Although not shown in the figures, a bonding agent can be employed to bond the dielectric 104 to the center conductor 102. In some example embodiments, the dielectric 104 can be, but is not limited to, taped, solid, or foamed polymer or fluoropolymer. For example, the dielectric 104 can be foamed polyethylene (PE).

The conductive tape 106 surrounds the dielectric 104, and generally serves to minimize the ingress and egress of high frequency electromagnetic fields to/from the center conductor 102. For example, in some applications, the conductive tape 106 can shield against electromagnetic fields that are greater than or equal to about 50 MHz.

As disclosed in FIG. 1C, the conductive tape 106 is a laminate tape that includes an inner metal layer 106A, a polymer strength layer 106B, and an outer metal layer 106C. The inner and outer metal layers 106A and 106C may be formed from various metals including, but not limited to, aluminum or copper, for example. The polymer strength layer 106B may be formed from various polymers including, but not limited to, polypropylene, polyethylene, or polyester, for example. The polymer strength layer 106B functions to strengthen and stiffen the relatively thin foil-like inner and outer metal layers 106A and 106C.

It is understood that the conductive tape 106 can instead include, but is not limited to, the following layers: polymer strength/metal, and metal/polymer strength/metal/polymer strength/metal, for example. It is understood, however, that the discussion herein of tape is not limited to tape having any particular combinations of layers. It is also understood that a bonding agent layer, such as a bonding agent layer including ethylene acrylic acid or polyvinyl chloride for example, may be employed to bond the conductive tape 106 to the dielectric 104.

The color or brightness of the polymer strength layer 106B visually contrasts with the surrounding and adjacent metal layer 106C. The polymer strength layer 106B may be colored red, blue, or green, for example. The color red contrasts well with the color of aluminum, while the colors green and blue contrast well with the colors of aluminum and copper. The colors listed above are examples only, and any other contrasting color combinations could be substituted in the above examples. Likewise, a change in color brightness, such as a simply lighter or darker color than the surrounding and adjacent metal layer 106C, could also be substituted in the above examples. The polymer strength layer 106B may be colored or brightened by adding a color concentrate to the polymer strength layer 106B, for example. The color concentrate added to the polymer strength layer 106B may further have fluorescence properties so that the polymer strength layer 106B can emit light.

Also, the natural color and brightness of the metal layer 106C can be changed in order to increase the visual contrast with the color or brightness of the polymer strength layer 106B. For example, an aluminum metal layer can be treated with a nitride treatment to change the color of the aluminum metal layer to a gold color in order to increase the visual contrast with the color or brightness of the polymer strength layer 106B.

The braid 108 surrounds the conductive tape 106, and generally serves to minimize the ingress and egress of low frequency electromagnetic fields to/from the center conductor 102. For example, in some applications, the braid 108 can shield against electromagnetic fields that are less than about 50 MHz. The braid 108 can be formed from inter-woven, fine gauge aluminum or copper wires, such as 34 American wire gauge (AWG) wires, for example. It is understood, however, that the discussion herein of braid is not limited to braid formed from any particular type or size of wire.

The jacket 110 surrounds the braid 108, and generally serves to protect the internal components of the coaxial cable 100 from external contaminants, such as dust, moisture, and oils, for example. In a typical embodiment, the jacket 110 also functions to protect the coaxial cable 100 (and its internal components) from being crushed or otherwise misshapen from an external force. The jacket 110 can be formed from a relatively rigid material such as, but not limited to, polyethylene (PE), high-density polyethylene (HDPE), low-density polyethylene (LDPE), or linear low-density polyethylene (LLDPE), or some combination thereof. The jacket 110 may instead be formed from a relatively less rigid and more pliable material such as, but not limited to, foamed PE, polyvinyl chloride (PVC), or polyurethane (PU), or some combination thereof. The actual material or combination of materials used might be indicated by the particular application/environment contemplated.

As disclosed in FIG. 1D, after a portion of the jacket 110 has been cut away, and a portion of the braid 108 has been peeled back over the jacket 110, a portion of the metal layer 106C of the conductive tape 106 is exposed. Unlike a standard conductive tape in which the polymer strength layer 106B is generally colorless and translucent, the visually contrasting color or brightness of the polymer strength layer 106B of the conductive tape 106 enables the polymer strength layer 106B to show through the cracks 106C′ in the metal layer 106C.

As the visually contrasting color or brightness of the polymer strength layer 106B shows through the cracks 106C′, the polymer strength layer 106B visually highlights the existence and precise position of each of the cracks 106C′ in the metal layer 106C. The visually contrasting color or brightness of the polymer strength layer 106B thus enables the cracks 106C′ to be visually detected by a cable technician with the naked eye, even in low-lighting conditions. As the cracks 106C′ in the metal layer 106C degrade the shielding effectiveness of the metal layer 106C, the visual identification of the cracks 106C′ in the metal layer 106C alerts a cable technician to the need to repair or replace the coaxial cable 100.

It is understood that the cracks 106C′ that inadvertently form in the metal layer 106C may have shapes and sizes other than the shapes and sizes of the cracks 106C′ disclosed in FIG. 1D. For example, the cracks 106C′ that inadvertently form in the metal layer 106C may run generally circumferentially instead of lengthwise. Further, the cracks 106C′ in the metal layer 106C may be shaped as punctures or tears, depending on the cause(s) of the cracks 106C′.

### II. Alternative Coaxial Cables

Although the example embodiments are described in the context of the standard-shield coaxial cable 100, it is understood that other coaxial cable configurations can include conductive tape with a visually contrasting polymer strength layer including, but not limited to: single-shield coaxial cable (where the shielding includes only a single conductive tape layer), tri-shield coaxial cable (where the shielding includes one braid layer and two tape layers), quad-shield coaxial cable (where the shielding includes two braid layers and two tape layers), and messengered coaxial cable (where the coaxial cable includes a messenger wire embedded in the jacket that provides support in situations where the cable aerially spans long distances, such as 75 feet or more).

The example embodiments disclosed herein may be embodied in other specific forms. The example embodiments disclosed herein are to be considered in all respects only as illustrative and not restrictive.

What is claimed is:

1. A conductive tape for use in a coaxial cable, the conductive tape comprising:
an inner metal layer;
an outer metal layer; and
a polymer strength layer positioned between and adjacent to the inner and outer metal layers, a color or brightness of the polymer strength layer visually contrasting with the outer metal layer.

2. The conductive tape as recited in claim 1, wherein the inner and outer metal layers each comprises aluminum or copper.

3. The conductive tape as recited in claim 1, further comprising a bonding agent layer adjacent to the inner metal layer opposite the polymer strength layer.

4. The conductive tape as recited in claim 1, wherein the polymer strength layer comprises polypropylene, polyethylene, polyester, or some combination thereof.

5. The conductive tape as recited in claim 1, wherein the polymer strength layer is colored red, blue, or green.

6. A coaxial cable comprising:
a center conductor surrounded by a dielectric;
a conductive tape surrounding the dielectric, the conductive tape comprising:
an inner metal layer surrounding the dielectric;
a polymer strength layer surrounding and adjacent to the inner metal layer; and
an outer metal layer surrounding and adjacent to the polymer strength layer, a color or brightness of the polymer strength layer visually contrasting with the outer metal layer; and
a jacket surrounding the conductive tape.

7. The coaxial cable as recited in claim 6, wherein the inner and outer metal layers each comprises aluminum.

8. The coaxial cable as recited in claim 7, wherein the conductive tape further comprises a bonding agent layer surrounding the dielectric and surrounded by the inner metal layer.

9. The coaxial cable as recited in claim 6, wherein the inner and outer metal layers each comprises copper.

10. The coaxial cable as recited in claim 6, wherein the polymer strength layer is colored red, blue, or green.

11. The coaxial cable as recited in claim 6, further comprising a conductive braid surrounding the conductive tape.

12. The coaxial cable as recited in claim 11, further comprising:
a second conductive braid surrounded by the conductive tape; and
a second conductive tape surrounded by the second conductive braid.

13. The coaxial cable as recited in claim 6, wherein the polymer strength layer is colored red.

14. The coaxial cable as recited in claim 6, further comprising a coaxial cable connector attached to a terminal section of the coaxial cable.

15. The coaxial cable as recited in claim 14, further comprising a second coaxial cable connector attached to a second terminal section of the coaxial cable.

16. The coaxial cable as recited in claim 6, wherein the polymer strength layer comprises polyester.

17. A coaxial cable jumper comprising:
a coaxial cable having a first coaxial cable connector attached to a first terminal section of the coaxial cable and a second coaxial cable connector attached to a second terminal section of the coaxial cable, the coaxial cable comprising:
a center conductor surrounded by a dielectric;
a conductive tape surrounding the dielectric, the conductive tape comprising:
an inner metal layer surrounding the dielectric;
a polymer strength layer surrounding and adjacent to the inner metal layer; and
an outer metal layer surrounding and adjacent to the polymer strength layer, a color or brightness of the polymer strength layer visually contrasting with the outer metal layer; and
a jacket surrounding the conductive tape.

18. The coaxial cable jumper as recited in claim 17, further comprising a conductive braid surrounding the conductive tape.

19. The coaxial cable jumper as recited in claim 18, further comprising:
a conductive braid surrounded by the conductive tape; and
a second conductive tape surrounded by the conductive braid.

20. The coaxial cable jumper as recited in claim 17, wherein the polymer strength layer is colored red.
